(19) United States
(12) Patent Application Publication
(10) Pub. No.: US 2026/0316485 A1
(43) Pub. Date: Oct. 15, 2026

(54) Combination Pen with Integrated Handcuff Tooling

(71) Applicant: Jacob Manna, Goshen, NY (US)

(72) Inventor: Jacob Manna, Goshen, NY (US)

(21) Appl. No.: 19/174,974

(22) Filed: Apr. 10, 2025

(51) Int. Cl. B43K 29/00; B43K 24/06; E05B 19/00

(52) U.S. Cl. CPC B43K 29/00; E05B 19/0082; B43K 24/06

(57) ABSTRACT

A combination pen includes an elongated housing having a front end and a rear end. A writing mechanism is positioned within the front end and includes a first cartridge with a writing tip and a second cartridge with a non-writing tip configured to engage a mechanical feature of a restraint device. A selector assembly is operatively coupled to the writing mechanism and is rotatable in opposing directions to selectively extend either cartridge through an opening at the front end of the housing. A key assembly is positioned within the rear end of the housing and includes an elongated key member slidable between a retracted position and an extended position in which a portion of the key member projects from the housing. A resilient member is configured to assist retraction of the key member by storing energy when the key is extended and returning to a resting state when the key is retracted.

### FIELD OF INVENTION

The present invention relates to multi-functional writing instruments and, more particularly, to a pen incorporating both writing functionality and concealed components for interacting with mechanical restraint devices.

### BACKGROUND

Law enforcement and military personnel are frequently required to carry a broad array of mission-critical tools, including firearms, restraints, communication equipment, and documentation instruments. In high-mobility environments, the need to minimize both the weight and volume of carried gear places significant demands on equipment design. Among these tools, handcuff keys and writing instruments are standard issue and are expected to be readily accessible during daily duty. The ability to secure and document an arrest, for example, often requires both a pen and the use of handcuffs in rapid succession. Yet these items are traditionally carried separately, increasing the potential for loss, delay, or logistical inconvenience in the field.

In response to such operational needs, combination tools have been developed that integrate multiple functionalities into a single object. Some prior devices combine a handcuff key with a writing instrument, typically by mounting the key at one end of the pen or integrating it directly into the writing cartridge. While these tools offer convenience, they often do so at the expense of durability, ergonomics, or discretion. In particular, externally mounted or permanently exposed handcuff keys may raise safety concerns, as they are immediately visible and identifiable, potentially allowing detainees or bystanders to recognize and exploit the tool's secondary purpose. Moreover, such designs may compromise the balance and comfort expected of a high-quality pen, making them unsuitable for frequent or extended writing use.

Another class of products attempts to conceal handcuff keys within screw-on caps or threaded compartments in tactical or so-called “survival” pens. While these designs offer improved concealment, they often rely on multi-step deployment procedures that are impractical in time-sensitive situations. Furthermore, such pens typically have a rugged or aggressive appearance, diverging significantly from the aesthetic profile of standard civilian or professional writing instruments. This may limit their use in low-profile or administrative settings, where discretion and non-threatening appearance are paramount.

Existing combination devices also tend to conflate handcuff engagement functions. For example, while some pens integrate a handcuff key, they omit the ability to engage the double-locking mechanism present in many modern restraints. Double-locking is a critical safety feature that prevents over-tightening of the cuffs after initial application. Its omission from compact tools reduces their functional completeness and may require the operator to carry a second, dedicated tool. Efforts to integrate both a key and a double-lock pin have historically resulted in bulky, overengineered products that are difficult to carry discreetly or operate one-handed.

Despite prior attempts, the need persists for a compact, unobtrusive, and ergonomically viable tool that provides law enforcement personnel with rapid access to both writing and handcuffing functions—including the full range of locking and unlocking operations—without requiring multiple components or compromising the form factor of a conventional pen. A solution that combines these capabilities into a unified, aesthetically neutral platform, while maintaining intuitive, tool-free deployment, would address longstanding practical gaps in the field.

It is within this context that the present invention is provided.

### SUMMARY

A combination pen is provided that integrates both writing functionality and restraint-related mechanical functionality within a unified housing. The pen includes an elongated housing having a front end and a rear end. A writing mechanism is disposed within the front end and includes a first cartridge with a writing tip for depositing ink, and a second cartridge with a non-writing tip shaped to engage a mechanical component of a restraint device. A selector assembly operatively coupled to the writing mechanism is configured to rotate in opposing directions to selectively extend either the writing tip or the non-writing tip through an opening at the front end of the housing.

A key assembly is disposed within the rear end of the housing and includes an elongated key member slidable between a retracted position and an extended position in which a portion of the key member projects from the rear end. A resilient member is configured to enter a compressed state when the key is extended and to assist with retraction upon release of the locking interface. The spring remains uncompressed when the key is retracted, thereby reducing the risk of unintentional deployment due to incidental pressure on the external control element, such as during insertion into a pocket or gear strap. The locking interface is actuatable via an external control element mounted on the housing and configured to engage a bolt-action guide path.

In some embodiments, the first and second cartridges are mounted in parallel within a common rotatable carrier, which simplifies the internal layout of the writing mechanism and allows a single rotational input to control cartridge extension.

In further embodiments, the selector assembly comprises a rotary collar that is operatively coupled to the cartridge carrier. This provides an intuitive and low-profile user interface for switching between writing and non-writing elements.

In some embodiments, the non-writing tip of the second cartridge is shaped to visually resemble a writing tip. This promotes concealment of its secondary function and preserves the external appearance of an ordinary pen.

In some embodiments, the non-writing tip comprises a hardened metal pin configured to engage a double-lock mechanism of a standard handcuff. This allows the pen to perform a restraint-locking function without requiring a separate tool.

In further embodiments, the selector assembly is configured to allow only one of the cartridges to be extended at a time, reducing risk of interference or mechanical conflict between elements.

In some embodiments, the elongated key member includes a distal portion shaped to rotate a locking mechanism, and in further embodiments, that distal portion is replaceable. This supports compatibility with multiple keying standards without modifying the overall housing.

In some embodiments, the external control element that actuates the locking interface is implemented as a clip mounted to the housing. This allows the actuation mechanism to be discreetly integrated into a component already present for carrying convenience.

In further embodiments, the clip follows a defined guide path in the housing, and movement along this path unlocks the key member. In yet further embodiments, the guide path defines a bolt-action motion, requiring a combination of linear and lateral movements to release the locking mechanism.

In some embodiments, the locking interface includes a detent that engages with the key shaft. This provides a simple and reliable means of retaining the key in its retracted position.

In further embodiments, the resilient member is an integrally molded spring structure. This reduces part count and simplifies manufacturing by eliminating the need for a separate spring element.

In some embodiments, the key shaft is guided by an internal track within the housing, ensuring smooth and aligned deployment of the key member.

In some embodiments, the housing includes a front portion containing the writing mechanism and a rear portion containing the key assembly, with the two portions joined by threaded engagement. This allows for assembly or maintenance of each half independently.

In further embodiments, the pen is styled and dimensioned to resemble a luxury writing instrument, preserving discreetness and compatibility with professional or administrative environments.

In some embodiments, the key member is entirely concealed within the housing when in the retracted position, preventing visual identification of its secondary function.

In further embodiments, the resilient member biases the key shaft along a linear axis aligned with the housing's longitudinal axis. This alignment simplifies the deployment geometry and minimizes internal complexity.

In some embodiments, the first cartridge is refillable, which allows the device to serve as a long-term writing instrument without compromising its secondary functionality.

In some embodiments, the selector assembly includes an internal cam mechanism configured to translate rotational input into linear extension and retraction of the cartridges. This supports precise and repeatable control of the selectable output.

### BRIEF DESCRIPTION OF THE DRAWINGS

Various embodiments of the invention are disclosed in the following detailed description and accompanying drawings.

FIG. 1 illustrates an example combination pen in a fully assembled, external perspective view.

FIG. 2 illustrates an example cross-sectional view of the rear portion of the pen showing internal components of the key assembly.

FIG. 3 illustrates an example full longitudinal cross-section of the pen showing both the writing mechanism and the key assembly.

FIG. 4 illustrates an example enlarged view of the rear end of the pen showing the key aperture.

FIG. 5 illustrates an example perspective view of the pen with the key member in an extended position.

FIG. 6 illustrates an example side view of the rear portion of the pen with the clip engaged in the retracted and locked position.

FIG. 7 illustrates an example partially disassembled view of the pen showing the internal cartridge assembly separated from the housing.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The term “pen” refers to any writing instrument configured to deposit marking material, such as ink or pigment, onto a surface. This includes, but is not limited to, ballpoint pens, gel pens, rollerball pens, and fountain pens. In one example implementation, the pen comprises a refillable ballpoint cartridge containing an oil-based ink, housed within a molded polymer or anodized aluminum barrel.

The term “cartridge” refers to any elongate insertable element contained within the pen housing that performs a writing or tool function. This includes ink cartridges for writing and solid, non-inked inserts for engaging mechanical components. In one example implementation, a first cartridge may be a standard D1-type refill, while a second cartridge may comprise a machined stainless steel rod shaped to resemble a writing tip and configured to engage a restraint mechanism.

The term “non-writing tip” refers to the exposed end of a cartridge that is not configured to deposit ink or pigment, but rather to interface with a mechanical component. This includes, for example, pins shaped to actuate a locking element in a handcuff assembly. In one example implementation, the non-writing tip may be formed from a corrosion-resistant steel alloy, such as 17-4PH stainless steel, and have a rounded profile similar to a pen nib to maintain visual symmetry.

The term “selector assembly” refers to any mechanism by which a user can selectively actuate or position one of multiple internal components within the pen. This includes rotary selectors, cams, sliders, or magnetic switching mechanisms. In one example implementation, the selector assembly may comprise a rotating collar that interfaces with a cam track to extend and retract either of two cartridges along a shared linear path.

The term “key assembly” refers to any internal structure configured to store and selectively deploy a mechanical key used to interface with locking or restraint devices. In one example implementation, the key assembly may include a sliding key shaft mounted within an internal guide channel and terminating in a key head shaped to fit standard law enforcement handcuffs.

The term “biasing member” refers to any elastic or resilient component configured to apply force to a movable element. In the context of the key assembly, the biasing member assists with retraction by applying force only after being compressed during manual extension of the key member. This includes coiled springs, leaf springs, molded flexible arms, or compressible elastomers. In one example implementation, the biasing member may be a unitary spring molded from a polymer such as acetal (POM) or polyether ether ketone (PEEK) and integrally formed with the pen housing to reduce part count.

The term “locking interface” refers to any mechanical structure configured to retain the key member in a selected position until intentionally released. This includes, but is not limited to, detents, cam locks, over-center mechanisms, or frictional engagement systems. In one example implementation, the locking interface may comprise a recessed notch in the housing wall that receives a protrusion on the sliding key shaft, released by lateral movement of an external control element.

The term “external control element” refers to any component accessible to a user that actuates an internal mechanism. This includes clips, buttons, sliders, or rotating collars. In one example implementation, the external control element may be a pocket clip formed of spring steel or injection-molded polymer, configured to follow a bolt-action track on the housing to unlock the key assembly.

The materials used in the construction of the pen may vary depending on manufacturing preferences, cost, and operational durability. In some embodiments, the housing may be formed from anodized aluminum, stainless steel, carbon-reinforced polymer, or high-impact ABS. Internal components such as cartridges, shafts, and cams may be fabricated using CNC-machined metal, injection-molded thermoplastics, or laser-cut composites. Surface finishes may include matte bead-blasting, chemical etching, or electroplating to enhance grip or reduce reflectivity.

All structural features described herein may be integrated as a monolithic assembly or composed of multiple discrete parts joined via press-fit, threading, adhesive bonding, or welding techniques. The invention encompasses both permanent and user-serviceable constructions. Dimensions, tolerances, and materials may be adjusted to accommodate alternate use environments, user preferences, or jurisdictional restraint standards.

### DESCRIPTION OF DRAWINGS

The present disclosure relates to a combination pen that integrates both conventional writing functionality and components for interacting with restraint mechanisms, such as handcuffs, within a compact and unified form factor. The device is configured to selectively deploy either a writing cartridge or a non-writing mechanical tip through a single actuation mechanism, and further includes a concealed key assembly at the opposite end of the pen. All components are housed within a structure that retains the appearance and proportions of a standard professional writing instrument.

Existing combination tools intended for law enforcement often compromise between accessibility, concealment, and ergonomics. Some expose functional elements externally, diminishing discretion and introducing safety concerns. Others require screw-on caps or multi-step disassembly procedures, rendering them impractical in field conditions that demand speed and simplicity. Still others fail to incorporate the full range of mechanical interactions required for modern handcuffs, such as the ability to engage the double-lock feature.

The combination pen described herein addresses these and other limitations by providing dual-function writing and restraint-interaction capabilities in a single, aesthetically neutral device. The writing end of the pen includes a rotary selector mechanism that allows a user to choose between a conventional ink cartridge and a structurally similar non-writing tip, which may be configured to interface with a double-locking mechanism. This arrangement allows for rapid selection between writing and mechanical engagement functions without altering the external form or requiring the use of tools.

At the opposite end of the pen, a spring-biased key assembly is housed within the rear portion of the device. The key member remains fully concealed when retracted, and is deployed via an actuation mechanism integrated into an external control element, such as a movable clip. A locking interface retains the key member in its retracted position until intentionally released, at which point the stored spring energy drives the key into the extended position for immediate use.

The integrated nature of the device allows both components—the writing assembly and the key assembly—to operate independently while sharing a single housing. This results in a tool that is portable, discreet, and rapidly deployable without requiring disassembly or drawing attention to its secondary functionality. The device is also readily adaptable to varying operational requirements, including differing key profiles or restraint types, through modular or replaceable components.

The following description sets forth various example embodiments of the invention with reference to the accompanying drawings. It should be understood that the examples are illustrative rather than limiting, and that various modifications, substitutions, and equivalents may be employed without departing from the scope of the invention as defined by the claims.

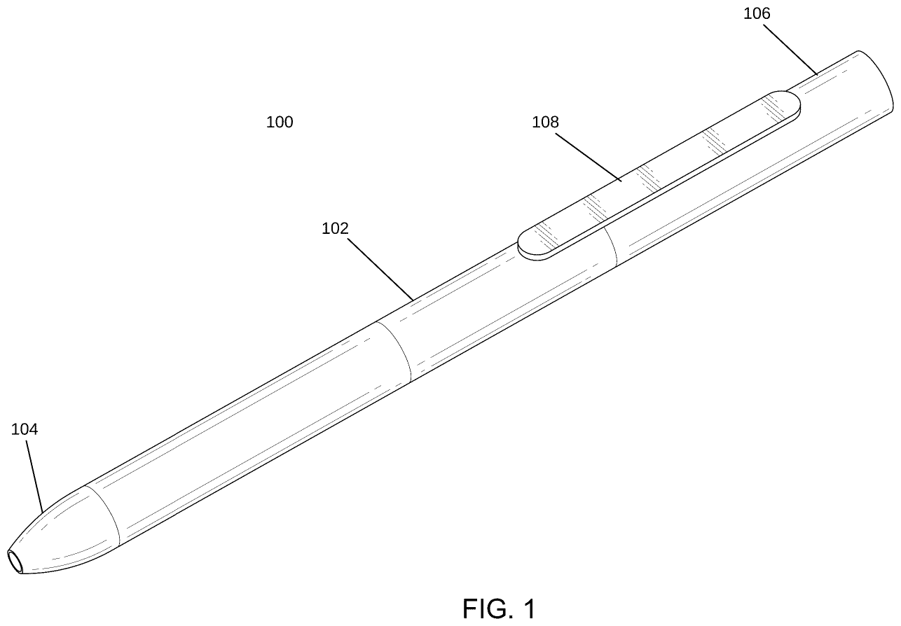

FIG. 1 illustrates an external perspective view of a combination pen 100 in its closed, fully assembled state. The combination pen 100 includes an elongated housing 102 having a front end 104 and a rear end 106. The housing 102 is generally cylindrical and is configured to resemble the form factor of a conventional luxury pen. While the illustrated embodiment shows a uniform tubular construction with gently tapered ends, in other implementations the housing 102 may feature aesthetic or functional contours, grip enhancements, or material transitions. The housing 102 may be constructed from any suitable material such as anodized aluminum, stainless steel, carbon-fiber composite, or high-strength polymer. Surface finishing may include brushed metal, matte coatings, or high-gloss lacquer depending on the intended end-user context, whether for formal administrative carry or tactical field deployment.

Mounted along the exterior of the housing 102 is a clip 108 configured for secure attachment to clothing or gear. The clip 108 is illustrated in a spring-loaded configuration flush against the housing, but in some embodiments it may be offset or articulated. The clip 108 serves a dual function in some implementations, acting not only as a retention device but also as a control element for actuating an internal locking mechanism associated with a deployable key member. In embodiments where the clip 108 forms part of a bolt-action actuation system, it may be configured to move along a guide track recessed in the surface of the housing 102, following a defined linear and lateral path to release the internal locking interface. The clip 108 may be formed from spring steel, molded polymer, or other resilient materials, and may be permanently affixed or user-replaceable.

The elongated housing 102 is divided into two functional regions, a front portion that houses a dual-cartridge writing mechanism and a rear portion that conceals a spring-loaded key assembly. The division between these two regions may be implemented as a threaded coupling or a press-fit interface, depending on design and serviceability preferences. The selector mechanism for the writing assembly, which is not visible in the present figure, may be integrated into a rotatable portion of the front housing or actuated via internal cam linkage. The writing end may selectively extend either a conventional ink cartridge or a second cartridge having a non-writing tip configured to engage a restraint device, such as the double-lock mechanism on a set of standard handcuffs. In some embodiments, the non-writing tip may be visually indistinguishable from a typical ballpoint tip to preserve the pen's outward appearance.

Although not shown in FIG. 1, the rear end 106 of the pen houses an internal key assembly that includes a concealed key shaft biased by an internal spring toward an extended position. In the configuration depicted, the key member is retained in a retracted state, fully enclosed within the body of the housing 102. Upon actuation of the locking interface, for example through motion of the clip 108, the key may be released and projected into a usable position. The internal components of the pen are configured such that both writing and key deployment mechanisms operate independently without requiring disassembly or cap removal.

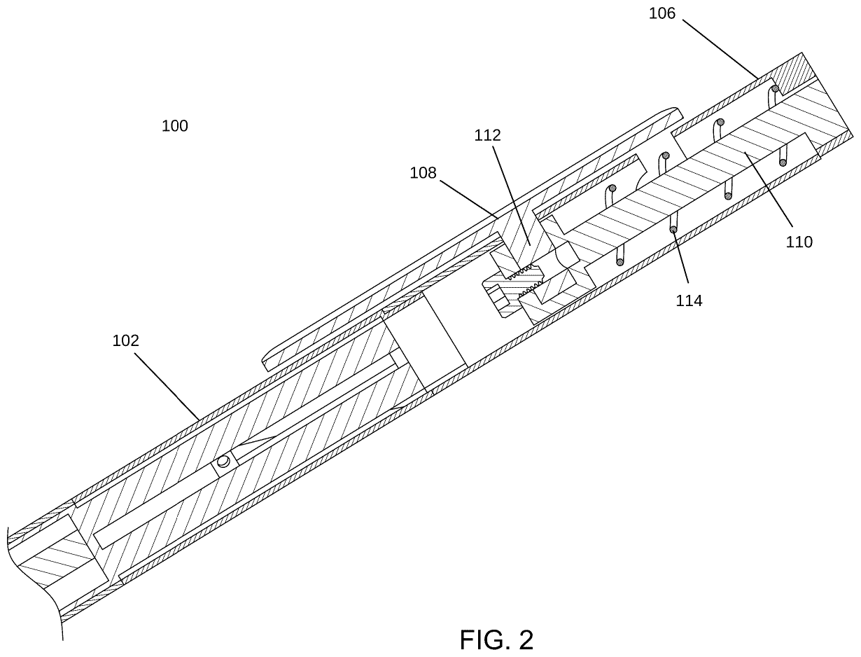

FIG. 2 illustrates a sectional view of the rear portion of the combination pen 100, exposing internal structural features associated with the key assembly. The housing 102 is shown in partial longitudinal cross-section to reveal the concealed key member 110 in its retracted configuration. The key member 110 is an elongated shaft that extends along the interior of the rear housing segment and terminates in a shaped end portion configured to interface with a restraint locking mechanism, such as a standard handcuff key slot. The shaft of the key member 110 is slidable along a linear axis and is retained in the illustrated position by engagement with an internal locking interface 112. In some embodiments, the shaped end portion of the key member 110 may be interchangeable to support compliance with varying key standards used across jurisdictions.

Positioned adjacent to the key member 110 is a biasing member 114, shown in this embodiment as a molded spring structure integrally formed along the inner wall of the housing 102. biasing member 114 is compressed during extension of the key member 110, and upon release, assists in returning the key to the retracted position. In its resting state, when the key is fully retracted, the spring is uncompressed. The spring configuration shown includes a series of cantilevered arms extending from the inner housing surface and angled forward relative to the direction of key travel. While a unitary spring is depicted, alternative embodiments may employ discrete coil springs, leaf springs, or elastomeric elements depending on manufacturing and performance requirements. The internal geometry of the housing 102 is configured to guide the key member 110 along a linear path during deployment and retraction, using internal walls or channels as alignment features.

Also visible in this view is the clip 108, shown mounted to the exterior of the housing 102 and extending into a recessed control cavity. A portion of the clip 108 penetrates into the housing wall and interfaces with the locking interface 112, such that movement of the clip along a defined actuation path releases the key member 110. In one embodiment, the control path comprises a bolt-action track formed on the exterior of the housing, requiring a short linear press followed by lateral displacement to disengage the locking interface 112. The motion profile may be designed to resist accidental actuation while remaining operable with one hand. The clip 108 may be formed from spring steel or durable polymer and may include tactile detents or markings to indicate locked and released positions.

This figure also more clearly illustrates the internal connection between the clip 108 and the underlying mechanism. The locking interface 112 is implemented in this example as a mechanical catch that engages a notch or detent formed along the body of the key member 110. Other embodiments may implement magnetic, frictional, or cam-based locking mechanisms. Once the key member 110 is extended via manual actuation of the clip along the bolt-action track, the biasing member 114 becomes compressed. The biasing force then assists in retracting the key when the locking interface is disengaged. In the retracted position, the spring returns to its uncompressed resting state.

Notably, all internal features remain completely concealed from view when the device is assembled and the key member 110 is in its retracted position, preserving the outward appearance of a conventional writing instrument.

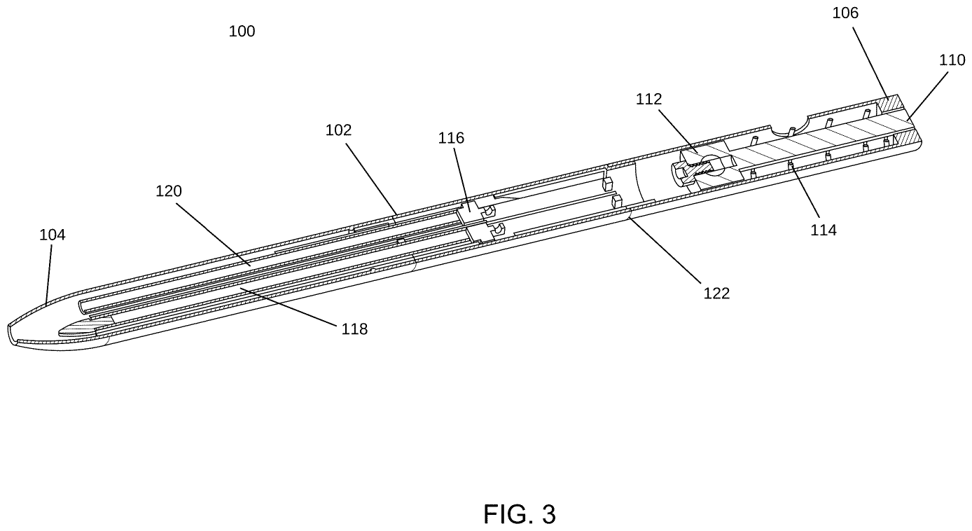

FIG. 3 provides a longitudinal cross-sectional view of the full combination pen 100, illustrating both the rear key deployment assembly and the front dual-cartridge writing mechanism in a single integrated configuration. This view clearly shows the spatial layout and internal alignment of the functional components within the housing 102, and highlights how the front and rear assemblies are structurally and mechanically separated yet functionally coexistent within a shared elongated body.

In the front portion of the pen, two cartridges are positioned side by side within a common carrier 116. The first cartridge 118 terminates in a writing tip configured to deposit ink in typical fashion, while the second cartridge 120 terminates in a non-writing tip that is shaped similarly but is configured to engage a restraint mechanism, such as a handcuff's double-lock pin. Both cartridges are housed in an internal assembly that allows either one to be selectively extended through an opening at the front end 104 of the housing 102 via a selector mechanism, not fully visible in this view but understood to be operably coupled to the cartridge carrier 116. The cross-sectional view illustrates that both cartridges are aligned in parallel and share a common longitudinal axis for output alignment, minimizing the complexity of the switching geometry.

This figure also confirms the functional modularity of the pen's architecture, where the front and rear portions are coupled along a discrete join line 122. In one implementation, this coupling is achieved via threaded engagement, permitting separation of the housing 102 into two portions for servicing or cartridge replacement. This modular design allows each assembly—writing and key—to be independently manufactured, serviced, or adapted for alternate functionalities without requiring changes to the overall structure.

The rear portion of the figure once again depicts the concealed key member 110 in its retracted position, aligned along the housing's longitudinal axis. The surrounding spring 114 and locking interface 112 are shown in greater context here, illustrating how the spring-loaded action of the key member is isolated from the writing mechanism by a supporting wall structure within the housing. The configuration ensures that operation of the key assembly does not interfere with the function or alignment of the cartridges at the front of the device.

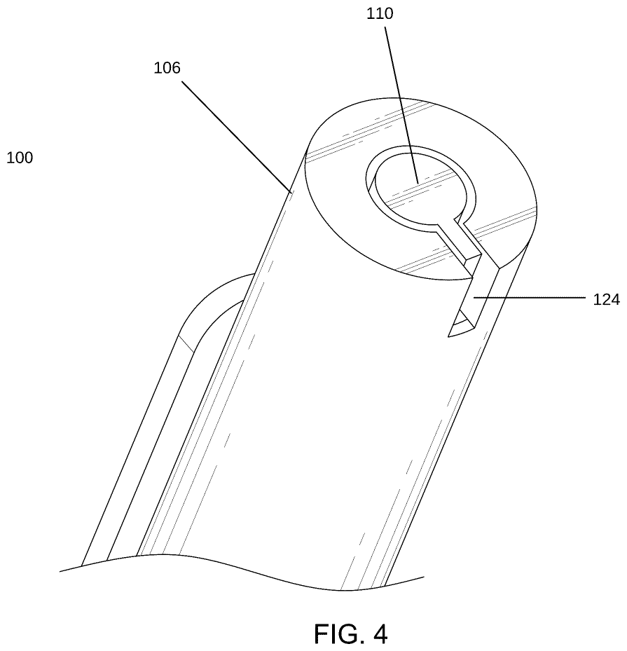

FIG. 4 shows an enlarged external perspective view of the rear end 106 of the combination pen 100, specifically illustrating the outlet aperture 124 through which the key member is extendable. The aperture 124 is shaped to accommodate the profile of the deployable key member and includes a circular portion with an integrated keyway notch that conforms to the head geometry of the concealed key. This configuration ensures guided passage and rotational clearance when the key member transitions between retracted and extended positions. The aperture may also serve to prevent accidental rotation of the key shaft during use, depending on key geometry. While the key member is not shown in the extended state in this figure, the aperture 124 represents the point of exit for the spring-biased deployment described in earlier figures. The clip 108 is partially visible adjacent to the aperture and may act as the external control element used to release the key member from its locked position within the housing.

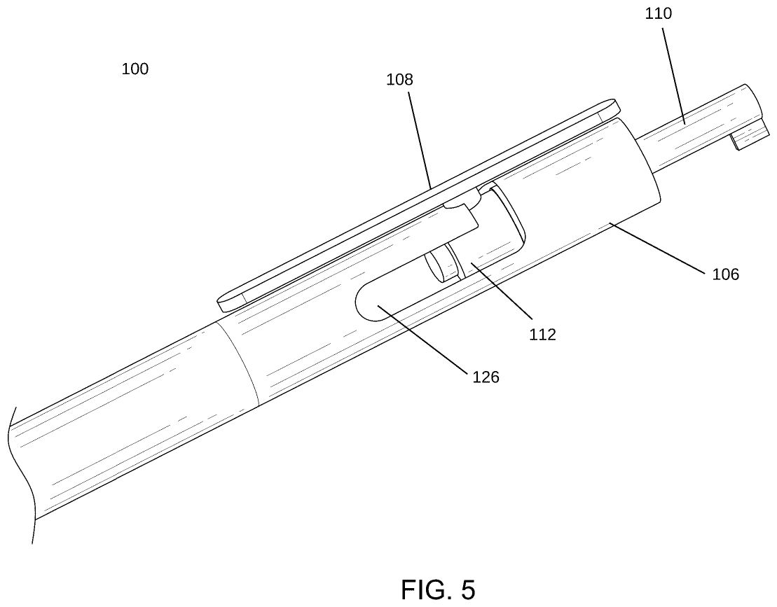

FIG. 5 shows a partial external perspective view of the rear end 106 of the combination pen 100, with the key member 110 in its extended position. This view provides visual confirmation of the deployment pathway previously described, with the key member 110 now projecting axially from the housing 102 through the aperture 124. The key member is shown in a locked-out state, ready for engagement with a restraint device. The external clip 108 is also visible and is shown partially displaced along a track on the housing surface, consistent with a bolt-action or guided actuation system. The actuation track 126, which guides the lateral and longitudinal movement of the clip 108, is now more clearly defined and visible in this figure, indicating a mechanical interface used to unlock the key member 110 from its retracted position. This view illustrates how the deployment can be achieved while preserving the compact and pen-like profile of the device.

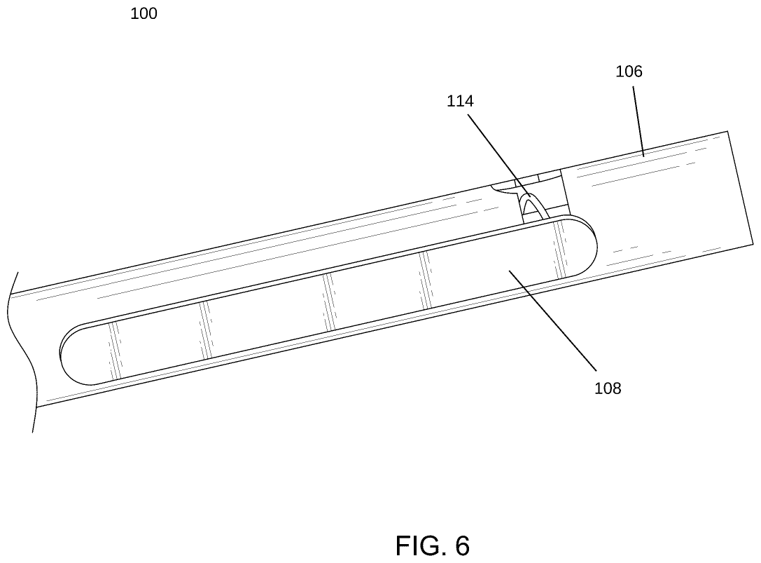

FIG. 6 shows a side elevation view of the rear portion of the combination pen 100, illustrating the key member 110 in its fully retracted and locked configuration within the housing 102. This figure highlights the external profile of the control mechanism, particularly the bolt-action path 126 along which the clip 108 is configured to move. The interaction between the clip 108 and the key locking interface is suggested by the positioning of a raised follower feature, which engages the actuation path and secures the key member against the bias of the internal spring. The fully seated clip position depicted here corresponds to the key member being concealed within the housing, preserving the streamlined appearance of the pen and preventing unintended deployment. This view also emphasizes how the actuation track 126 is integrated flush with the outer surface of the housing to avoid obstruction or snagging during pocket carry or manipulation.

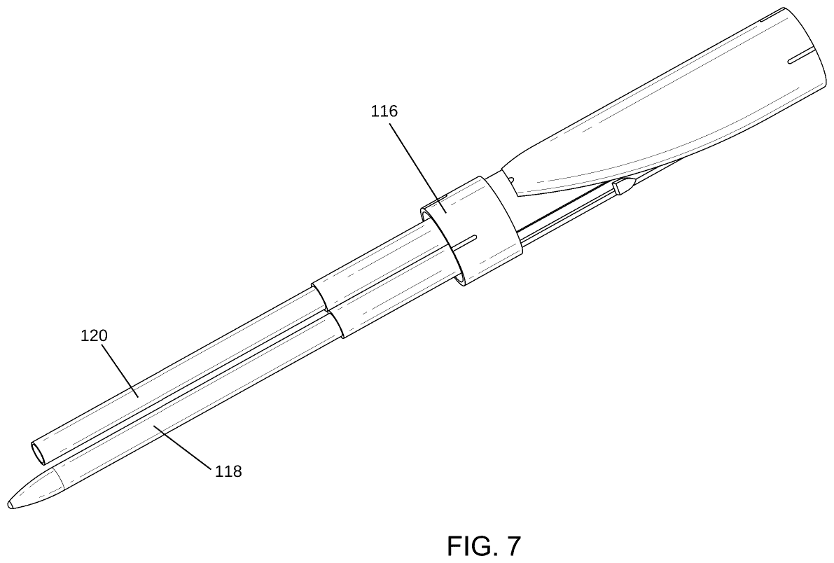

FIG. 7 illustrates an exploded or partially disassembled perspective view of the combination pen 100, showing the internal cartridge assembly removed from the main housing 102. In this view, both the first cartridge 118, which terminates in a conventional ink-writing tip, and the second cartridge 120, which terminates in a non-writing tip configured to engage a restraint mechanism, are visible and arranged side by side. The cartridges are secured within a shared selector assembly 116 that allows either to be selectively extended through the pen's front end depending on the rotational direction of an external actuator, such as a twistable collar or barrel segment.

This figure more clearly shows the alignment and spacing between the cartridges, which are housed in parallel to conserve axial space and allow simplified switching via rotational indexing. The assembly is supported by a central guide rod or rotation hub that extends from the selector mechanism and stabilizes the movement of the cartridge carrier during actuation. The selector assembly 116 may contain an internal cam or detent structure to enable precise rotational indexing between positions and may optionally include tactile or audible feedback features to confirm cartridge engagement.

Also shown in this figure is the rear housing segment separated from the front, highlighting the pen's modular construction. The connection interface 122 between the two housing segments is visible and may be implemented using male/female threading, a bayonet coupling, or a press-fit engagement, depending on the desired level of user serviceability and assembly complexity. In some embodiments, this modular division allows for easy access to internal components such as the spring, locking mechanism, or cartridges for cleaning, replacement, or customization.

The clip 108 is shown in an extended position along with a portion of its guide rod and the internal follower segment that engages the bolt-action track. The orientation of the clip and its associated track in this figure offers a clearer understanding of how lateral movement interacts with the internal locking interface to release the key member. The combination of this bolt-action mechanism with a spring-assisted return ensures that the concealed key can be extended manually and then returned to its retracted position with the aid of stored spring energy. The spring remains uncompressed when the key is fully retracted, thereby preventing unintended actuation.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the combination pen of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A combination pen comprising:
an elongated housing having a front end and a rear end;
a writing mechanism disposed within the front end of the housing, the writing mechanism including:
a first cartridge comprising a writing tip configured to deposit ink, and
a second cartridge comprising a non-writing tip configured to engage a mechanical component of a restraint device;
a selector assembly operatively coupled to the writing mechanism, the selector assembly being configured to rotate in opposing directions to selectively extend either the writing tip of the first cartridge or the non-writing tip of the second cartridge through an opening at the front end of the housing;
a key assembly disposed within the rear end of the housing, the key assembly including an elongated key member slidable between a retracted position within the housing and an extended position in which a portion of the key member projects from the rear end of the housing;
a resilient member positioned within the housing and configured to be compressed as the key member is extended, such that the resilient member assists in returning the key member to its retracted position when released; and
a locking interface configured to retain the key member in the retracted position against the bias of the resilient member, the locking interface being actuatable through an external control element mounted on the housing.

2. The combination pen of claim 1, wherein the first cartridge and the second cartridge are mounted in parallel within a common carrier that is rotatable relative to the housing.

3. The combination pen of claim 2, wherein the selector assembly comprises a rotary collar operatively coupled to the carrier to effect selective extension of the first or second cartridge.

4. The combination pen of claim 1, wherein the non-writing tip of the second cartridge has a shape and appearance generally resembling the writing tip of the first cartridge.

5. The combination pen of claim 1, wherein the non-writing tip of the second cartridge comprises a hardened metal pin configured to actuate a double-lock mechanism of a handcuff.

6. The combination pen of claim 1, wherein the selector assembly is configured such that only one of the first cartridge or second cartridge can be extended at a time.

7. The combination pen of claim 1, wherein the elongated key member comprises a distal portion shaped to rotate a locking mechanism of a restraint device.

8. The combination pen of claim 7, wherein the distal portion of the elongated key member is replaceable to accommodate different keying standards.

9. The combination pen of claim 1, wherein the external control element comprises a clip mounted on the housing.

10. The combination pen of claim 9, wherein the clip is movable along a defined guide path formed in the housing, and actuation of the clip along the guide path releases the locking interface.

11. The combination pen of claim 10, wherein the guide path defines a bolt-action motion comprising a first direction of movement followed by a second direction transverse to the first.

12. The combination pen of claim 1, wherein the locking interface comprises a detent configured to releasably engage a surface of the elongated key member.

13. The combination pen of claim 1, wherein the resilient member is an integrally formed spring molded into the housing.

14. The combination pen of claim 1, wherein the elongated key member is guided along an internal track formed within the housing.

15. The combination pen of claim 1, wherein the elongated housing comprises a first housing portion containing the writing mechanism and a second housing portion containing the key assembly, the first and second housing portions being releasably joined by threaded engagement.

16. The combination pen of claim 1, wherein the elongated housing is externally dimensioned and styled to resemble a luxury pen.

17. The combination pen of claim 1, wherein, in the retracted position, the elongated key member is entirely concealed within the housing.

18. The combination pen of claim 1, wherein the resilient member biases the elongated key member along a linear axis aligned with a longitudinal axis of the housing.

19. The combination pen of claim 1, wherein the first cartridge is a refillable ink cartridge.

20. The combination pen of claim 1, wherein the selector assembly includes an internal cam mechanism configured to advance and retract the first and second cartridges based on rotational input.
